(19) United States
(12) Patent Application Publication
(10) Pub. No.: US 2024/0128570 A1
(43) Pub. Date: Apr. 18, 2024

(54) WATERPROOF BATTERY PACK CASE CONFIGURED SUCH THAT OVER-FUSION THEREOF IS PREVENTED

(71) Applicant: LG ENERGY SOLUTION, LTD., Seoul (KR)

(72) Inventors: Jae Young JANG, Daejeon (KR); Jin Hyun LEE, Daejeon (KR); Sang Jin KIM, Daejeon (KR)

(73) Assignee: LG ENERGY SOLUTION, LTD., Seoul (KR)

(21) Appl. No.: 18/277,025

(22) PCT Filed: Feb. 23, 2022
(86) PCT No.: PCT/KR2022/002643

§ 371 Date: Aug. 11, 2023

(30) Foreign Application Priority Data
Feb. 25, 2021 (KR) 10-2021-0025584

(51) Int. Cl. H01M 50/24; B23K 20/10; H01M 50/244

(52) U.S. Cl. CPC H01M 50/24; B23K 20/10; H01M 50/244

(57) ABSTRACT

Discussed is a battery pack case that may include a first case and a second case configured such that outer peripheries of the first case and the second case are coupled to each other by ultrasonic welding, wherein the outer periphery of the first case comprises a flat portion and a projecting portion formed as a result of a middle of the first case in a thickness direction projecting from the flat portion. Further, the outer periphery of the second case comprises a receiving portion configured to be fused with the projecting portion and an outer guide portion projecting from the receiving portion so as to face the flat portion, and a control rib projecting from at least a part of the flat portion is provided.

### TECHNICAL FIELD

This application claims the benefit of priority to Korean Patent Application No. 2021-0025584 filed on Feb. 25, 2021, the disclosure of which is incorporated herein by reference in its entirety.

The present invention relates to a waterproof battery pack case having an over-fusion prevention structure. More particularly, the present invention relates to a battery pack case including an over-fusion prevention and waterproof structure capable of preventing external appearance defects from occurring at a coupling region of the battery pack case due to over-fusion when ultrasonic welding is performed for coupling of the battery pack case while performing a waterproof function.

### BACKGROUND ART

A battery pack constituted by secondary batteries connected to each other in series or in parallel is used as a high-output, high-capacity energy source for medium- or large-sized devices. The battery pack may include a plurality of battery cells, a structure configured to perform electrical connection between the battery cells, a structure configured to control the operation of the battery cells, and a structure configured to adjust heat generation/heat dissipation of the battery cells in a battery pack case, and coupling of the battery pack case is performed in the state in which the structures are received therein to manufacture the battery pack.

The battery pack case is manufactured using a polymer resin. As a coupling method of the battery pack case, there is used a method of pressurizing the polymer resin in a molten state using frictional heat by ultrasonic vibration in order to achieve coupling. If a coupling region of the battery pack case is over-fused or pressing force is inaccurately controlled, the molten resin flows outwards, whereby burrs are generated.

FIG. 1 is a vertical sectional view of a conventional battery pack case coupling region.

Referring to (a) of FIG. 1, the battery pack case is constituted by a first case 100 located above and a second case 200 located below. A projecting portion 110 is formed on a coupling region of the first case 100 at a middle part of the first case in a thickness direction (x-axis direction) so as to project downwards therefrom, and a grooved portion 230 is formed in a coupling region of the second case 200 at a middle part of the second case in a thickness direction (x-axis direction) so as to be concave. The projecting portion 110 of the first case 100 is inserted into and fixed to the grooved portion 230 of the second case 200, whereby the battery pack case is assembled.

The projecting portion 110 includes an energy director 111 formed at an end thereof such that the width of the energy director in the thickness direction (x-axis direction) is gradually decreased. When vibration is applied to the first case 100 and/or the second case 200, the energy director 111 is melted in the grooved portion 230 of the second case 200 while being vibrated, whereby the grooved portion 230 is filled with the projecting portion 110 or melted polymer of the energy director 111.

If the first case is excessively pressed against the second case in the state in which the energy director 111 is melted, the energy director may be over-fused, whereby some of the melted energy director may flow out of the case. As a result, burrs B may be generated, as shown in (b) of FIG. 1.

Further, (b) of FIG. 1 shows the state in which the burrs B are generated at the coupling regions of the first case 100 and the second case 200 due to over-fusion. In order to prevent generation of defects, such as the burrs, it is important to maintain a uniform distance between the first case and the second case in a height direction at the coupling regions of the first case and the second case.

Patent Document 1 discloses a battery pack including a first case and a second case, wherein a first connection surface of the first case and a second connection surface of the second case are coupled to each other by ultrasonic welding. The second connection surface and the first connection surface are coupled to each other by ultrasonic welding in the state in which a vertical groove of the second connection surface and a stopper rib and a second fusion rib located at opposite sides of the vertical groove are located opposite a stopper surface of the first connection surface and a first fusion rib of the first connection surface, and a flow gap configured to prevent a fused structure from being formed on a surface as the result of introduction of plastic melted at the time of fusion.

In Patent Document 1, the configuration of the flow gap has difficulty completely preventing melted plastic from flowing out of the flow gap. The stopper rib and the stopper surface must be welded to each other, and the second fusion rib and the first connection surface must be welded to each other, whereby a welding process is complicated, it is necessary to adjust welding intensity, and it is difficult to completely prevent the welded regions from flowing out of the flow gap in a melted state.

Patent Document 2 discloses a battery pack configured such that a battery pack case includes a front case and a rear case, a plurality of fusion protrusions made of a resin is formed along an edge of the rear case, i.e. the part of the rear case that contacts the front case, and outflow prevention recesses configured to prevent outflow of the fusion protrusions are formed along an edge of the front case at the region of the front case that contacts the fusion protrusions of the rear case.

The outflow prevention recesses of Patent Document 2 have difficulty completely preventing the fusion protrusions from flowing out of the outflow prevention recesses when the fusion protrusions are melted. That is, time and force control is necessary when the front case and the rear case are coupled to each other, and, if the fusion protrusions flow out of the outflow prevention recesses in the state in which the fusion protrusions are melted, it is difficult to prevent external appearance defects, such as the burrs of FIG. 1, from occurring between the battery cases.

Therefore, there is a need for a battery pack case having a structure capable of fundamentally preventing generation of external appearance defects as the result of an energy director of a battery case melted by vibration heat flowing out of the battery case while having a waterproof structure.
Japanese Registered Patent Publication No. 3702090 (“Patent Document 1”)
Korean Patent Application Publication No. 2004-0085478 (“Patent Document 2”)

### DISCLOSURE

### Technical Problem

The present invention has been made in view of the above problems, and it is an object of the present invention to provide a battery pack case including an over-fusion prevention and waterproof structure capable of preventing the occurrence of external appearance defects on a coupling region of the battery pack case due to over-fusion when ultrasonic welding is performed in order to achieve coupling of the battery pack case while performing a waterproof function.

### Technical Solution

A battery pack case according to one or more embodiments of the present invention to accomplish the above object includes a first case and a second case configured such that outer peripheries of the first case and the second case are coupled to each other by ultrasonic welding, wherein the outer periphery of the first case includes a flat portion and a projecting portion formed as the result of a middle of the first case in a thickness direction projecting from the flat portion, the outer periphery of the second case includes a receiving portion configured to be fused with the projecting portion and an outer guide portion projecting from the receiving portion so as to face the flat portion, and a control rib projecting from at least a part of the flat portion is provided.

The projecting portion may include an energy director disposed at a distal end of the projecting portion, the energy director being configured such that at least a part of the energy director is melted when fusion is performed by welding, and a support portion configured to support the energy director.

The energy director may be configured such that the sectional area of a distal end of the energy director is less than the sectional area of a proximal end of the energy director.

The energy director may be configured to have an inclined structure in which a sectional area of the energy director between the proximal end and the distal end is gradually decreased toward the distal end of the energy director.

The control rib may have a projecting height equal to or greater than the height of the support portion and less than the height of the distal end of the energy director.

The projecting portion may be continuously formed along the outer periphery of the first case, the receiving portion may be continuously formed along the outer periphery of the second case, the control rib may be continuously or discontinuously formed at an inner surface of the battery pack case based on the projecting portion, the outer guide portion may be continuously formed at an outer surface of the battery pack case based on the projecting portion, and the flat portion and the outer guide portion may not contact each other while the control rib and the receiving portion may contact each other when the first case and the second case may be coupled to each other.

When the control rib is discontinuously formed, an inner guide portion projecting from the receiving portion so as to face the flat portion may be further formed at the inner surface of the battery pack case based on the projecting portion.

The projecting portion may be inserted between the inner guide portion and the outer guide portion of the second case.

The inner guide portion may be provided with a rib recess configured to allow the control rib to be inserted thereinto.

When the first case and the second case are coupled to each other, the projection portion and the outer guide portion may not contact each other.

The sectional thickness of the first case and the sectional thickness of the second case may be equal to each other.

In addition, the present invention may provide various combinations of the above solving means.

### Advantageous Effects

As is apparent from the above description, in a battery pack case according to the present invention, a support structure is formed at coupling regions of a first case and a second case, whereby it is possible to maintain a uniform coupling distance between the first case and the second case even when coupling force is excessively applied to the first case and the second case in the state in which a projecting portion of the first case is melted.

Since the coupling distance between the first case and the second case is maintained uniform, as described above, it is possible to prevent generation of burrs due to over-fusion at the coupling regions of the first case and the second case, whereby it is possible to reduce an external appearance defect rate.

In addition, the first case is completely coupled to the second case by fusion in the state in which the projecting portion of the first case is melted, whereby it is possible to effectively secure airtightness of a battery pack, and therefore it is possible to surely prevent permeation of external moisture into the battery pack.

### DESCRIPTION OF DRAWINGS

FIG. 1 is a vertical sectional view of a conventional battery pack case coupling region.

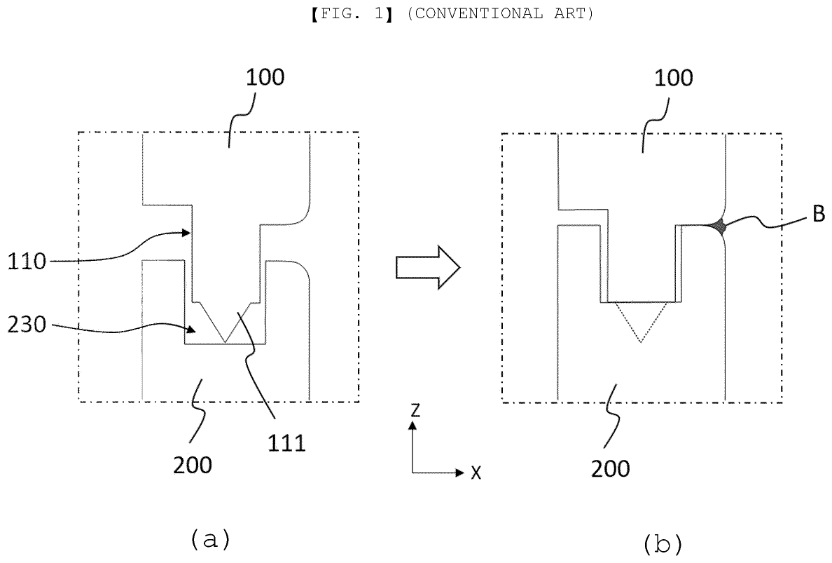

FIG. 2 is a perspective view of a first case according to a first embodiment of the present invention.

FIG. 3 is a perspective view of a second case according to a first embodiment of the present invention.

FIG. 4 is a vertical sectional view of a case coupling region during welding according to a first embodiment of the present invention.

FIG. 5 is a vertical sectional view of the case coupling region after welding according to the first embodiment of the present invention.

FIG. 6 is a perspective view of the case coupling region according to the first embodiment of the present invention.

FIG. 7 is a perspective view of a case coupling region according to a second embodiment of the present invention.

FIG. 8 is a perspective view of a case coupling region according to a third embodiment of the present invention.

FIG. 9 is a schematic view showing various shapes of a control rib according to the present invention.

### BEST MODE

Now, example embodiments of the present invention will be described in detail with reference to the accompanying drawings such that the example embodiments of the present invention can be easily implemented by a person having ordinary skill in the art to which the present invention pertains. In describing the principle of operation of the example embodiments of the present invention in detail, however, a detailed description of known functions and configurations incorporated herein will be omitted when the same may obscure the subject matter of the present invention.

In addition, the same reference numbers will be used throughout the drawings to refer to parts that perform similar functions or operations. In the case in which one part is said to be connected to another part throughout the specification, not only may the one part be directly connected to the other part, but also, the one part may be indirectly connected to the other part via a further part. In addition, that a certain element is included does not mean that other elements are excluded, but means that such elements may be further included unless mentioned otherwise.

In addition, a description to embody elements through limitation or addition may be applied to all inventions, unless particularly restricted, and does not limit a specific invention.

Also, in the description of the invention and the claims of the present application, singular forms are intended to include plural forms unless mentioned otherwise.

Also, in the description of the invention and the claims of the present application, “or” includes “and” unless mentioned otherwise. Therefore, “including A or B” means three cases, namely, the case including A, the case including B, and the case including A and B.

In addition, all numeric ranges include the lowest value, the highest value, and all intermediate values therebetween unless the context clearly indicates otherwise.

Hereinafter, embodiments of the present invention will be described in detail with reference to the accompanying drawings.

A battery pack case according to the present invention includes a first case and a second case, which are separated from each other. The first case and the second case have a structure in which the first case and the second case are coupled to each other by fusion.

Specifically, a projecting portion is formed on a coupling region of the first case at a middle part of the first case in a thickness direction so as to project therefrom, and a receiving portion is formed in a coupling region of the second case at an inside of the second case in the thickness direction at which the receiving portion is located opposite the projecting portion. Consequently, the projecting portion and the receiving portion may be coupled to each other by fusion in the state in which the projecting portion and the receiving portion face each other.

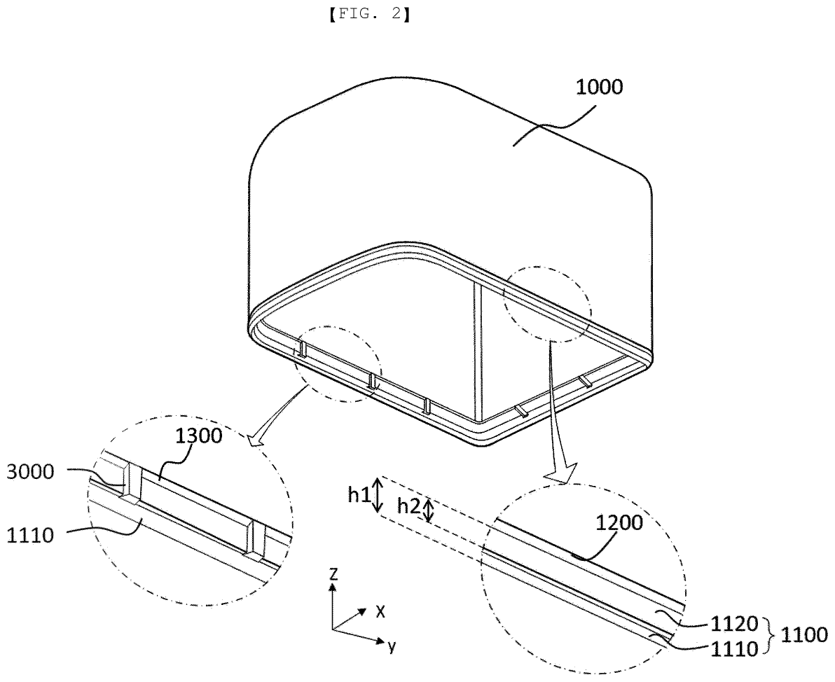

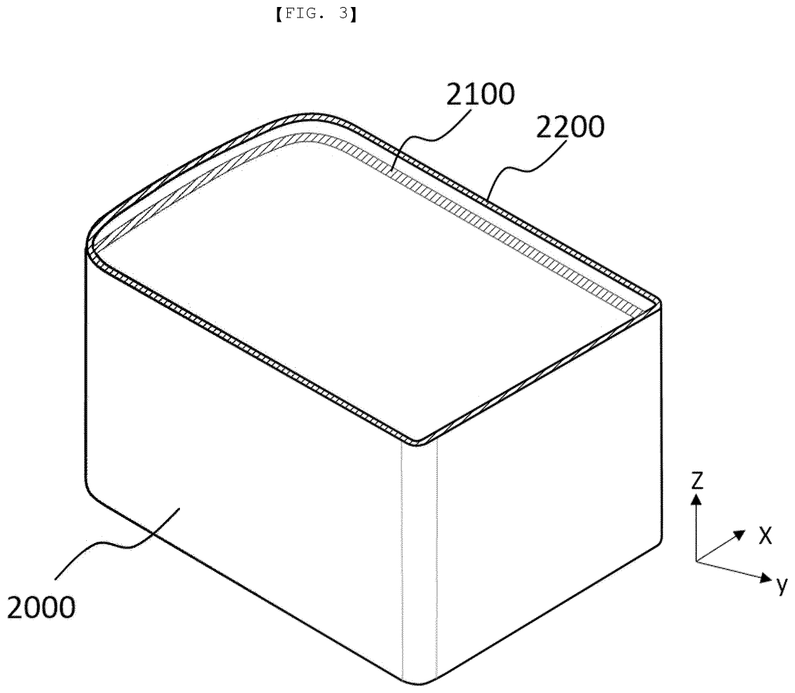

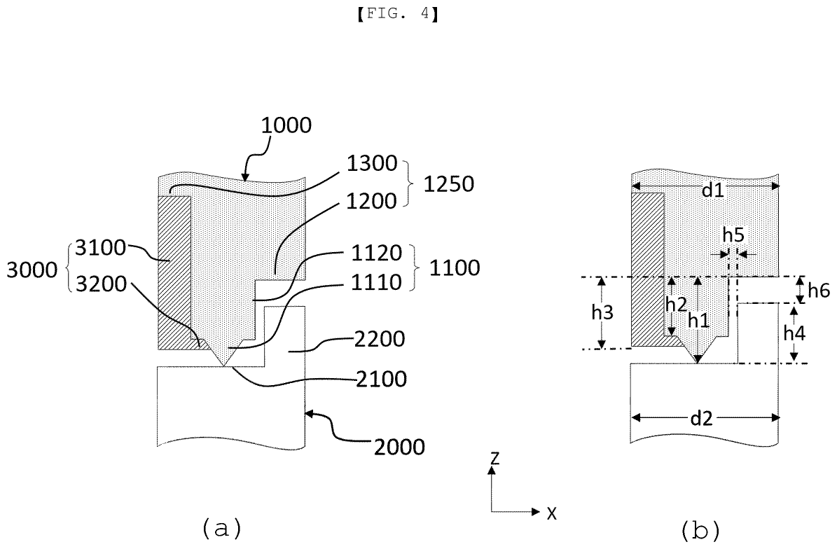

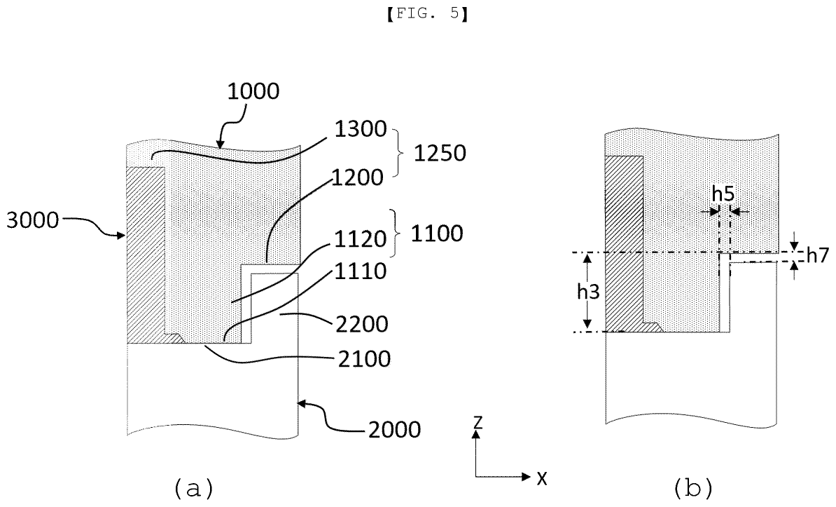

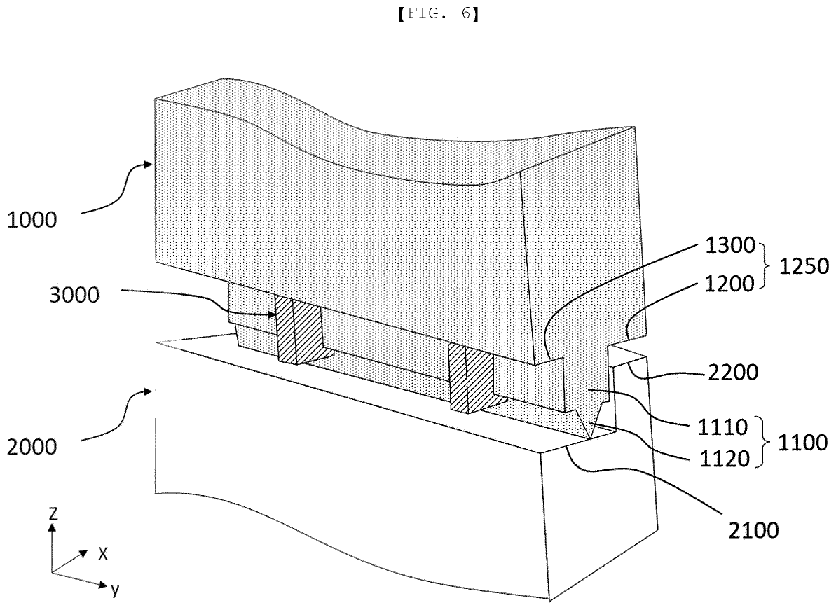

In connection therewith, FIG. 2 is a perspective view of a first case according to a first embodiment of the present invention, FIG. 3 is a perspective view of a second case according to a first embodiment of the present invention, FIG. 4 is a vertical sectional view of a case coupling region during welding according to a first embodiment of the present invention, FIG. 5 is a vertical sectional view of the case coupling region after welding according to the first embodiment of the present invention, and FIG. 6 is a perspective view of the case coupling region according to the first embodiment of the present invention.

Referring to FIGS. 2 and 3, the first case 1000 is configured to have a structure in which a case wall is located at a side surface and an upper surface thereof and a lower surface thereof is open, and the second case 2000 is configured to have a structure in which a case wall is located at a side surface and a lower surface thereof and an upper surface thereof is open. In FIGS. 2 and 3, each of the first case and the second case is shown as having an approximately hexahedral shape. However, it is obvious that the shape of each of the first case and the second case is not limited to the shape shown in the figure as long as the first case and the second case receive a battery module and are coupled to each other to constitute a battery pack.

Here, the coupling region of the first case 1000 is located at an outer periphery thereof, which is a lower surface of the side wall, and includes a projecting portion 1100 formed as the result of a part of the outer periphery of the first case projecting in a downward direction (negative z-axis direction). The projection portion 1100 includes an energy director 1110 and a support portion 1120. At least one control rib 3000 may be located at an inner surface of the projection portion 1100 of the first case 1000 in tight contact therewith.

In addition, the coupling region of the second case 2000 is located at an outer periphery thereof, which is an upper surface of the side wall, and may include a receiving portion 2100 located opposite the projecting portion 1100 of the first case 1000 and an outer guide portion 2200 formed at an outer periphery of the receiving portion 2100 so as to extend upwards (z-axis direction). The horizontal section (xy plane) of the receiving portion 2100 may be formed so as to correspond to the horizontal sections (xy planes) of the support portion 1120 and the control rib 3000.

Hereinafter, the construction of coupling between the first case 1000 and the second case 2000 will be described in detail with reference to FIGS. 4 to 6.

Referring first to FIGS. 4 and 5, in the present invention, the thickness d1 of the first case and the thickness d2 of the second case are equal to each other as shown in (b) of FIG. 4, the projection portion 1100 formed on the outer periphery of the first case 1000 is in tight contact with the receiving portion 2100 of the second case 2000 as shown in (a) of FIG. 4. When ultrasonic vibration is applied to the first case 1000 and the second case 2000 in this state, the energy director 1110 located at an end of the projecting portion 1100 is melted by frictional heat generated at the part at which the projection portion 1100 of the first case 1000 and the receiving portion 2100 of the second case 2000 abut each other as shown in (a) of FIG. 5. The first case 1000 and the second case 2000 are coupled to each other by the melted energy director 1110 as shown in (b) of FIG. 5.

The outer periphery of the first case includes a flat portion 1250 and a projecting portion 1100 formed as the result of a part of the middle of the first case 1000 in the thickness direction (x-axis direction) projecting from the flat portion 1250. The projecting portion 1100 may include a support portion 1120 having a uniform sectional area in the downward direction (z-axis direction) and an energy director 1110 extending from a lower end of the support portion 1120 and having a gradually decreased sectional area. An outer flat portion 1200 is formed between an outside outer circumferential surface of the support portion 1120 (in a direction toward the outside of the case receiving portion) and an outside outer circumferential surface of the side wall of the first case 1000, and an inner flat portion 1300 is formed between an inside outer circumferential surface of the support portion 1120 (in a direction toward the inside of the case receiving portion) and an inside outer circumferential surface of the side wall of the first case 1000. Here, the outer flat portion 1200 is located opposite the outer guide portion 2200 of the second case 2000.

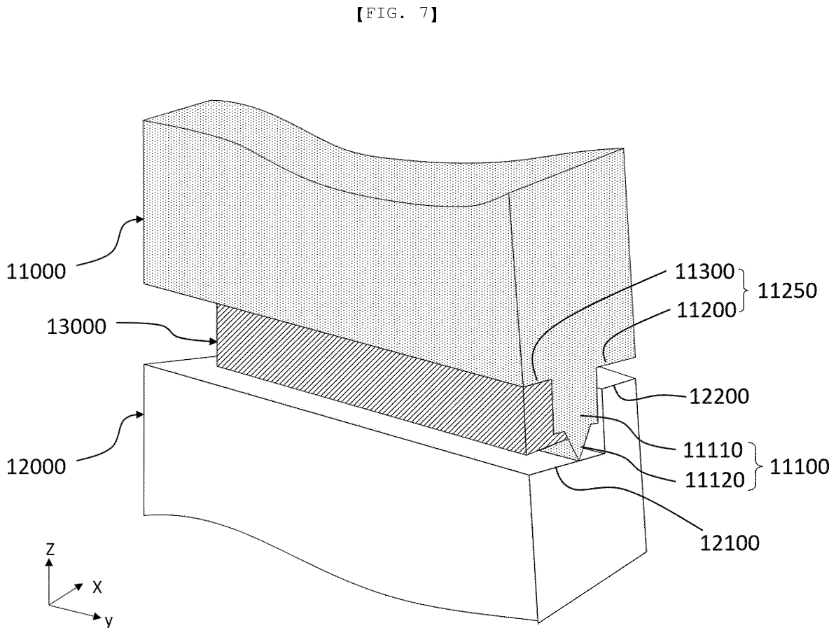

The flat portion 1250 is divided into an outer flat portion 1200 and an inner flat portion 1300, which may have a step therebetween. In FIGS. 4 and 5, the outer flat portion and the inner flat portion are shown as having a step therebetween. In FIGS. 6 and 7, the outer flat portion and the inner flat portion are shown as having no step therebetween.

In addition, the control rib 3000 is located in a state of being coupled to the inner flat portion 1300 and the projecting portion 1100. The control rib 3000 may include a rib support portion 3100 formed along the inside outer circumferential surface of the support portion 1120 and a rib extension portion 3200 formed at a lower part of the rib support portion 3100 so as to extend horizontally (xy plane). The rib extension portion 3200 may be formed so as to extend to a predetermined position between a lower end of the support portion 1120 and a lower distal end of the energy director 1110, and it is preferable for the rib extension portion 3200 to be formed at a position equivalent to 50% to 70% from the lower distal end of the energy director 1110 in the vertical direction (negative z-axis direction). The reason for this is that the lower distal end of the energy director 1110 is melted by ultrasonic vibration, whereby the first case 1000 and the second case 2000 are stably coupled to each other, which is advantageous in reducing case coupling defects due to over-fusion.

It is preferable for a lower end surface of the rib extension portion 3200 to be formed so as to correspond to an upper end surface of the receiving portion 2100 of the second case 2000, and it is more preferable for the lower end surface of the rib extension portion to be formed as a horizontal surface. The reason for this is that the rib extension portion 3200 and the receiving portion 2100 are brought into tight contact with each other in corresponding shapes after completion of case welding, whereby mutual stress is minimized, which is advantageous in stably coupling the first case 1000 and the second case 2000 to each other and is advantageous in preventing deformation of the battery pack case.

Before the first case 1000 and the second case 2000 are thermally fused, a space is formed between the projecting portion 1100 and the outer guide portion 2200, and an outer surface of the support portion 1120 and an inner surface of the outer guide portion 2200 are spaced apart from each other by a predetermined distance h5. In addition, the total height h1 of the projecting portion is greater than the height h4 of the outer guide portion and the height h3 between a lower end surface of the outer flat portion 1200 and the lower end surface of the rib extension portion 3200. The height h3 between the lower end surface of the outer flat portion 1200 and the lower end surface of the rib extension portion 3200 is greater than the height h4 of the outer guide portion. The reason for this is that tight contact between the outer flat portion 1200 and the outer guide portion 2200 is prevented after the first case 1000 and the second case 2000 are coupled to each other by fusion, which is advantageous in preventing case defects due to over-fusion.

After the first case 1000 and the second case 2000 are coupled to each other by fusion, the distance h7 between the lower end surface of the outer flat portion 1200 and an upper end surface of the outer guide portion 2200 may be 0.1 mm to 0.3 mm, preferably 0.2 mm, which is advantageous in preventing over-fusion while minimizing increase in volume of the battery pack case.

As described above, the coupling regions of the first case 1000 and the second case 2000 according to the first embodiment of the present invention are completely coupled to each other by fusion using the energy director 1110 melted by ultrasonic vibration, whereby it is possible to prevent coupling region defects due to over-fusion and to secure airtightness. Consequently, it is possible to prevent permeation of moisture and other liquid materials, and therefore waterproofing is achieved.

(b) of FIGS. 4 and 5 show that a step is formed between the inner flat portion 1300 and the outer flat portion 1200, whereby the vertical length of the control rib 3000 (z-axis direction) is greater than h3. However, this is merely an example, and the vertical length of the control rib 3000 (z-axis direction) may be equal to or less than h3 as long as the control rib is capable of performing a supporting function to prevent deformation, such as twisting or bending, of the projecting portion 1100 during a fusion process.

Referring to FIG. 6, the control rib 3000 may have a predetermined width (y-axis direction), and two or more control ribs may be discontinuously disposed on an inner surface of the battery pack case based on the projecting portion 1100 while being spaced apart from each other by a predetermined distance. It is preferable for one or more control ribs to be disposed at the side walls of the first case 1000 that face each other so as to be opposite each other. The reason for this is that the balance of the case coupling region is maintained at the time of case coupling by fusion, which is advantageous in effectively performing fusion without over-fusion.

FIG. 7 is a perspective view of a case coupling region according to a second embodiment of the present invention. As shown in FIG. 7, the second embodiment of the present invention is identical to the first embodiment described with reference to FIGS. 2 to 6 except for a control rib 13000. Hereinafter, therefore, only the control rib 13000, which is a different construction, will be described.

In the second embodiment, the control rib 13000 may be continuously located on the inner surface of the case at a projecting portion 11100.

After a first case 11000 and a second case 12000 are coupled to each other by fusion, the entireties of coupling regions of the first case 11000 and a second case 12000 are coupled to each other by fusion due to an energy director 11110 melted by ultrasonic vibration, and defects due to over-fusion are prevented by the control rib 13000, which is disposed on an inside outer circumferential surface of the projecting portion 11100, and a lower end surface of a rib extension portion (not shown) and an upper end surface of a receiving portion 12100 are brought into tight contact with each other, whereby airtightness is improved.

The control rib 13000 supports the entirety of the outer circumferential surface of the projecting portion 11100, whereby it is possible to prevent deformation, such as twisting or bending, of the projecting portion 11100 during a fusion coupling process and to improve stability and durability of the battery pack case.

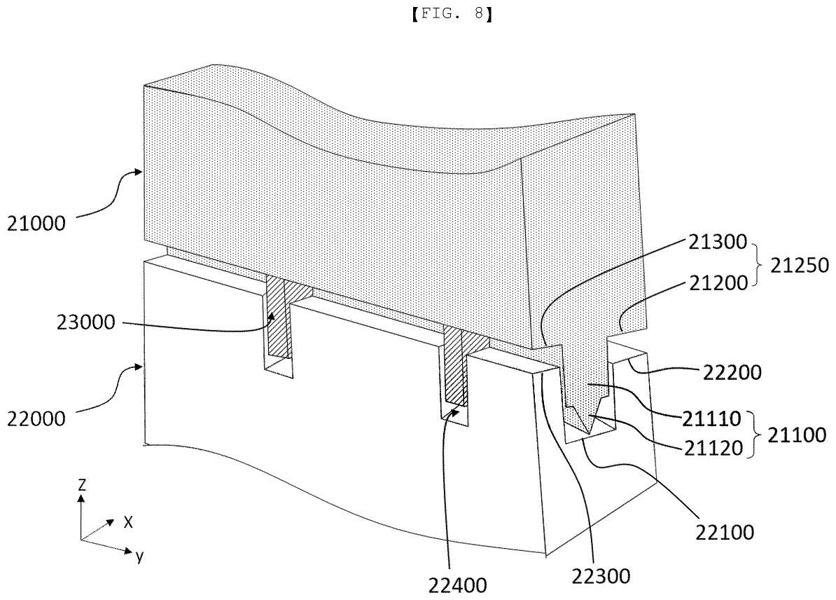

FIG. 8 is a perspective view of a case coupling region according to a third embodiment of the present invention. As shown in FIG. 8, the third embodiment of the present invention is identical to the first embodiment described with reference to FIGS. 2 to 6 except for an inner guide portion 22300 and a rib recess 22400 formed in the inner guide portion 22300. Hereinafter, therefore, only the inner guide portion 22300 and the rib recess 22400, which are different constructions, will be described.

In the third embodiment, an inner guide portion 22300 projecting upwards from a receiving portion 22100 so as to face an inner flat portion 21300 of a first case 21000 may be formed at an inner surface of a second case 22000. The inner guide portion 22300 may be continuously formed at the receiving portion 22100 of the second case 22000. A rib recess 22400 is formed at a position corresponding to a control rib 23000, and the control rib 23000 is located in the rib recess 22400 when the first case 21000 and the second case 22000 are coupled to each other by fusion. After the first case 21000 and the second case 22000 are coupled to each other by fusion, an upper end surface of the inner guide portion 22300 may be brought into tight contact with a lower end surface of the inner flat portion 21300. As a result, the inner guide portion 22300 supports the inner flat portion 21300 in tight contact therewith, which is advantageous in preventing deformation, such as twisting or bending, of the projecting portion 21100 during an ultrasonic welding process and improving stability and durability of the battery pack case.

It is preferable for a bottom surface of the rib recess 22400 to have the same surface (xy plane) as an upper end surface of the receiving portion 22100. The reason for this is that it is possible to more effectively prevent the flow of an energy director 21110 melted by ultrasonic vibration to the rib recess 22400, which is advantageous in improving airtightness of the battery pack case.

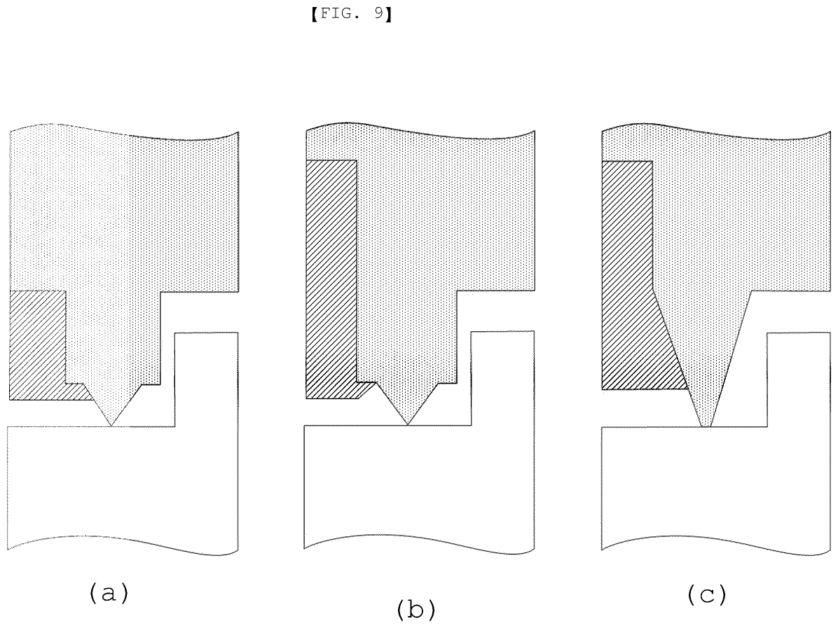

FIG. 9 is a schematic view showing various shapes of the control rib according to the present invention.

As shown in (a) of FIG. 9, the outer flat portion and the inner flat portion of the first case are formed so as to have the same height, whereby it is possible to easily form the projecting portion, which is advantageous in reducing consumption of the material for the control rib.

As shown in (b) of FIG. 9, the rib extension portion of the control rib is not horizontal, but a portion of an outer circumferential surface contact portion of the energy director is bent upwards. When the energy director is excessively melted, therefore, the melted energy director is received in a space between the bent surface of the rib extension portion and the receiving portion, and therefore it is possible to prevent the melted energy director from flowing out of the case coupling region.

As shown in (c) of FIG. 9, the projecting portion has no support portion, the energy director is directly formed on the flat portion of the first case, and the rib extension portion of the control rib is formed so as to has a relatively large size. This construction has advantages in that it is possible to easily form the projecting portion, and the enlarged rib extension portion supports the energy director, whereby it is possible to shorten an ultrasonic welding time while preventing deformation. In addition, a space is provided at the right side of the energy director, whereby it is possible to prevent the excessively melted polymer from flowing to the outside.

The battery pack case according to the present invention may be a case for battery packs that are used as energy sources for various types of devices, wherein a through-hole, through which electrode terminals of battery cells received in the battery pack case are withdrawn outwards, may be formed in the battery pack case.

Alternatively, a structure configured to stably mount the battery pack case in various types of devices, such as a hook structure, may be added to the battery pack case according to the present invention.

Those skilled in the art to which the present invention pertains will appreciate that various applications and modifications are possible within the category of the present invention based on the above description.

### DESCRIPTION OF REFERENCE SYMBOLS

100, 1000, 11000, 21000: First cases
110, 1100, 11100, 21100: Projecting portions
111, 1110, 11110, 21110: Energy directors
1120, 11120, 21120: Support portions
1200, 11200, 21200: Outer flat portions
1250, 11250, 21250: Flat portions
1300, 11300, 21300: Inner flat portions
200, 2000, 12000, 22000: Second cases
2100, 12100, 22100: Receiving portions
2200, 12200, 22200: Outer guide portions
230: Grooved portion
3000, 13000, 23000: Control ribs
3100: Rib support portion
3200: Rib extension portion
22300: Inner guide portion
22400: Rib recess
B: Burr
d1: Thickness of first case
d2: Thickness of second case
h1: Height of projecting portion
h2: Height of support portion
h3: Height between outer lower end surface of projecting portion and rib extension portion
h4: Height of outer guide portion
h5: Distance between outer surface of support portion and inner surface of outer guide portion
h6: Distance between outer lower end surface of projecting portion and upper end surface of outer guide portion before fusion
h7: Distance between outer lower end surface of projecting portion and upper end surface of outer guide portion after fusion

1. A battery pack case comprising:
a first case and a second case configured such that outer peripheries of the first case and the second case are coupled to each other by ultrasonic welding, wherein:
the outer periphery of the first case comprises a flat portion and a projecting portion formed as a result of a middle of the first case in a thickness direction projecting from the flat portion,
the outer periphery of the second case comprises a receiving portion configured to be fused with the projecting portion and an outer guide portion projecting from the receiving portion so as to face the flat portion, and
a control rib projecting from at least a part of the flat portion is provided.

2. The battery pack case according to claim 1, wherein the projecting portion comprises:
an energy director disposed at a distal end of the projecting portion, the energy director being configured such that at least a part of the energy director is melted when fusion is performed by welding; and
a support portion configured to support the energy director.

3. The battery pack case according to claim 2, wherein the energy director is configured such that a sectional area of a distal end of the energy director is less than a sectional area of a proximal end of the energy director.

4. The battery pack case according to claim 3, wherein the energy director is configured to have an inclined structure in which a sectional area of the energy director between the proximal end and the distal end is gradually decreased toward the distal end of the energy director.

5. The battery pack case according to claim 2, wherein the control rib has a projecting height equal to or greater than a height of the support portion and less than a height of a distal end of the energy director.

6. The battery pack case according to claim 1, wherein:
the projecting portion is continuously formed along the outer periphery of the first case,
the receiving portion is continuously formed along the outer periphery of the second case,
the control rib is continuously or discontinuously formed at an inner surface of the battery pack case based on the projecting portion,
the outer guide portion is continuously formed at an outer surface of the battery pack case based on the projecting portion, and
the flat portion and the outer guide portion do not contact each other, and the control rib and the receiving portion contact each other when the first case and the second case are coupled to each other.

7. The battery pack case according to claim 6, wherein, when the control rib is discontinuously formed, an inner guide portion projecting from the receiving portion so as to face the flat portion is further formed at the inner surface of the battery pack case based on the projecting portion.

8. The battery pack case according to claim 7, wherein the projecting portion is inserted between the inner guide portion and the outer guide portion of the second case.

9. The battery pack case according to claim 7, wherein the inner guide portion is provided with a rib recess configured to allow the control rib to be inserted thereinto.

10. The battery pack case according to claim 6, wherein, when the first case and the second case are coupled to each other, the projection portion and the outer guide portion do not contact each other.

11. The battery pack case according to claim 1, wherein a sectional thickness of the first case and a sectional thickness of the second case are equal to each other.
